(19) United States
(12) Patent Application Publication
(10) Pub. No.: US 2005/0037187 A1
(43) Pub. Date: Feb. 17, 2005

(54) Completely formed components laminated with preformable paint films and method for applying preformable paint films

(75) Inventors: Walter Aichholzer, Hemmingen (DE); Thomas Gruber, Neu-Ulm (DE); Karl Holdik, Ulm (DE); Bernd Homann, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/866,016

(22) Filed: Jun. 11, 2004

(30) Foreign Application Priority Data
Aug. 13, 2003 (DE) DE 103 37 155.9

(51) Int. Cl. B32B 1/00; B05D 3/02

(52) U.S. Cl. 428/221

(57) ABSTRACT

A method for applying a preformed paint film to the visible surface of a flat, completely formed component, in particular in the body section of motor vehicles, in which the preformed paint film is fixed in a mold tool, the formed component is introduced into the mold tool, the film is heated to or to above the glass-transition temperature of its polymer constituents, and the preformed paint film is fitted onto the visible surface of the formed component by moving the component into or through the film plane and/or by pressing the film onto the visible surface of the fixed component, as well as a painted component manufactured in accordance with this method, the preformed paint film being composed of one or more thermoplastic polymer layers and being formed as colored or effect film, and at least the top layer of the preformed paint film providing coloration and effect.

This claims the benefit of German Patent Application 103 37 155.9, filed 13 Aug. 2003 and hereby incorporated herein by reference.

### BACKGROUND

The present invention is directed to a method for laminating completely formed components with preformable paint films and to a component having an applied preformable paint film.

In recent times, preformable paint films are being used to an increasing degree as substitutes for conventional paint finishes. In this context, the preformable paint films are manufactured independently of the component to be later formed, and stored and transported on rolls or the like, for example. The preformable paint film is then applied to the component to be later formed, in place of a final paint finish. This procedure is particularly advantageous when the component is a component or a module of a larger subassembly and cannot be painted together with the other components of the subassembly. The preformable paint film makes it possible to achieve a uniform quality of color and effect of the paint that conforms with the other components of the subassembly. In comparison thereto, the color quality and effect quality of a conventional paint operation are greatly dependent on the undersurface or on the material of the component, and on the process conditions of the particular paint finishing operation.

Preformable paint films are known, for example, from the German Patent Applications DE 195 17 067 A1 or DE 195 17 068 A1. Both patent documents describe a film coated with a plurality of layers, as well as its use on a metallic substrate material, for example a sheet-metal panel for automobile manufacturing. These documents describe a plastic film on whose surface a filler composition is optionally applied. At least one pigmented paint layer is applied to the surface of the plastic film or filler coat. This is then sealed with a transparent plastic film in accordance with the first document, or painted over with a clear coat in accordance with the second document.

Methods for applying preformable paint films are described, for example, in German Patent DE 196 28 966 A1. In this context, a preformable paint film is applied to three-dimensionally curved surfaces of dimensionally stable substrates, the preformable paint film having at least one radiation-curable paint layer, which is partially cured, non-adhesively, before being applied to the substrate, and has one adhesive layer, and which is completely cured by radiation following the application. For application of the preformable paint film on the substrate, it is provided to heat the paint layer to its glass-transition temperature or to slightly above its glass-transition temperature. Ths method includes irradiation of the preformable paint film, which is generally a complex process step.

From the European Patent Application EP 04 190 01 A1, a method is known for combining the forming of a part from plastic material with the application of a paint layer. To this end, a preformable paint film is placed in a mold, and the plastic is cast in this mold. During the injection molding process, the preformable paint film, which is initially laid flat, is pressed against the walls of the mold, and thus conforms to the surface of the injection-molded component and is rigidly joined thereto. The method described in the European Patent Application is only applicable to injection-molded plastic parts having a film lamination.

### BRIEF SUMMARY OF THE IVENTION

An object of the present invention is to provide a simple method for laminating completely formed components with preformable paint films, as well as to provide components having suitable preformable paint films applied according to the method of the present invention.

In one preferred embodiment of the present invention, a method for applying a preformable paint film to a visible surface of a completely formed component is provided. The method includes the steps of providing a mold tool, and fixing the preformable paint film in the mold tool. According to a feature of the present invention, the completely formed component is introduced into the mold tool. The preformable paint film is heated to or above a glass-transition temperature of polymer constituents of the preformable paint film, and fitted onto the visible surface of the completely formed component by causing a pressing movement between the completely formed component and the heated preformable paint film.

In a second preferred embodiment of the present invention, a component is provided. The component has a laminated preformed paint film applied by a method having the steps of providing a mold tool, fixing a preformable paint film in the mold tool, and introducing a completely formed component into the mold tool. According to the invention, the preformable paint film is heated to or above a glass-transition temperature of polymer constituents of the preformable paint film, and the heated preformable paint film is fitted onto a visible surface of the completely formed component by causing a pressing movement between the component and the heated preformable paint film.

In another embodiment of the present invention, the component comprises a component of a motor vehicle body.

### BRIEF DESCRIPTION OF THE DRAWINGS

FIG. 1 schematically illustrates prior art methods A and B, and method C, according to an embodiment of the present invention, for applying a preformable paint film to a visible surface of a completely formed component.

FIG. 2 illustrates an exemplary completely formed component in the form of an automobile gas cap, shown from the bottom side, and having a preformable paint film layer, applied according to an embodiment of the present invention.

### DETAILED DESCRIPTION

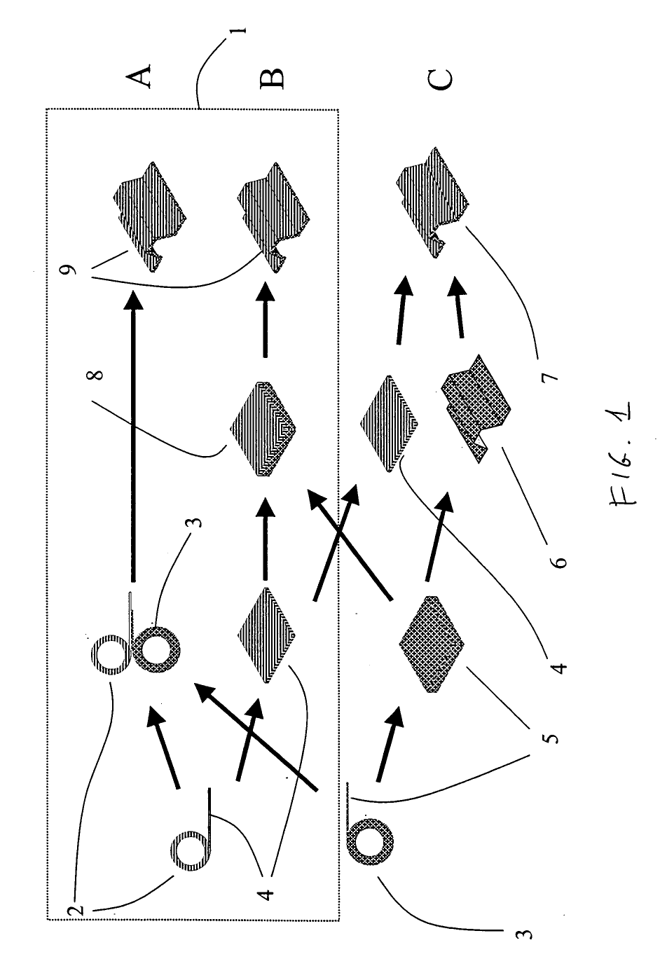

Referring now to the drawings, and initially to FIG. 1, there is illustrated schematically prior art methods A and B, indicated by the reference numeral 1, as well as a method C, according to an embodiment of the present invention. The schematic representation includes a supply roll 2 of a preformable paint film 4 and a supply roll 3 of a sheet metal band 5. There is also shown in the prior art methods, a sheet metal part 8 (method B) coated with a preformable paint film, and formed and shaped sheet metal sections 9, coated with a preformable paint film (methods A and B). In the method according to the present invention, there is shown a completely formed sheet metal component 6, a sheet of preformable paint film 4, which are pressed together to provide a component 7, laminated with the preformable paint film according to a feature of the method of the present invention.

The prior art methods A and B (1) begin from strips or rolls of preformable paint film 2 and sheet-metal section 3. In method A, the sheet metal strip 3 is joined to preformable paint film 4 from the corresponding roll 2. The sheet-metal section 3 is coated with preformable paint film, and then trimmed to size and reshaped and formed into a laminated component 9.

In the second known method B, the preformable paint film 4 and sheet-metal section 3 are first individually cut to size and then joined, thereby forming a coated, cut sheet-metal section 8. The coated, cut sheet-metal section 8 is then reshaped and formed, in turn, into a laminated component 9.

Method C, according to the present invention, initially provides for tailoring each of the wide strip to a sheet-metal part 5 and the preformable paint film to a film piece 4, separately. However, prior to the lamination of the preformable paint film on the sheet metal, the sheet metal 5 is reshaped into a completely formed component 6. It is first during the subsequent thermoforming process that preformable paint film piece 4 is adapted to the surface contour of the component 6 and permanently joined to the surface. As a result, a laminated component 7 is formed which is also coated in the edge region with preformable paint film.

In a first method step, the preformable paint film 4 is introduced into a mold tool, such as a mold tool in the shape of the completely formed component 6, such that the completely formed component 6 can be used as a die with the mold tool. The preformable paint film 4 is fixed in the mold tool. In this context, when working with the preformable paint films, one makes the distinction between a top side, which, in the component to be subsequently laminated, faces the side of normal use or the side exposed to weather, and a bottom side, which faces the component to be laminated. It is advantageous for the preformable paint film to be fastened evenly and smoothly, and with a slight tensile stress.

The completely formed component 6 is subsequently introduced into the mold tool on the side of the mold tool facing the bottom side of the preformable paint film 4. As noted above, the completely formed component 6 itself acts as a component of the mold tool, in particular in the manner of a die.

The completely formed component 6 is understood to include modules, subassembly parts, or components for multi-piece parts such as, for example, the body section of a motor vehicle, in their prescribed geometric form. The materials used for the completely formed components include metals, plastics and composite materials, in particular the standard materials used for the body section in motor-vehicle construction.

In the next step of the method according to the present invention, the preformable paint film is heated to make it plastically formable. Appropriate adhesives are optionally activated in the process as well.

The preformable paint films suited for the method comprise, at least in part, thermoplastic polymers or plastics. Typically, these preformable paint films have a polymeric and thermoplastic backing sheet, disposed on their bottom sides. The preformable paint films typically have a colored and/or effect layer, at least on their top sides. Generally, the top side is sealed by a clear-coat finish. In accordance with this exemplary embodiment of the method of the present invention, the preformable paint film 4 is heated to at least above the glass-transition temperature of its polymer constituents, making it easily formable. The preferred process temperature of the casting operation is within the range of 130 to 190° C. and may be set prior to the actual casting operation, or during the casting operation.

The completely formed component 6, which forms a part of the mold tool, is preferably not preheated or heated, or is at least below the glass-transition temperature of the polymers of the preformable paint film 4.

In the casting operation that follows, the preformable paint film 4 is fitted at least onto the visible surfaces of the completely formed component 6. This process step is also described as thermoforming.

In a first embodiment of the present invention, the completely formed component 6 is used as a mold tool, for example as a die, and is moved into or through the film plane of the drawn preformable paint film 4. In the process, the preformable paint film 4 is fitted uniformly onto the component 6 to provide the laminated component 7.

In a second embodiment of the present invention, the completely formed component 6 remains in its position, and the preformable paint film 4 is pressed at least onto the visible surface of the component in response to the application of a molding pressure. The molding pressure may be provided in a generally known manner by a gauge pressure or pressure above atmospheric or by a mold tool shaped to complement the form of the completely formed component 6.

It is likewise possible for both of the variants of the first and second exemplary embodiments of the method to be carried out one after the other, in such a way that they overlap with the greatest possible variation with respect to time, or also simultaneously.

In one especially preferred embodiment of the present invention, the preformable paint film 4 is not only pulled over the visible region of the completely formed component 6, but also over the defining borders and edges. In this connection, it is provided, in particular, for the trimmed edges of metallic components to be laminated. This is especially beneficial when, for example, the wide strips, customarily pretreated in body manufacturing with corrosion protection or other types of coatings, are used for manufacturing the completely formed components 6. Typically, the wide strips lose their coating at the trimmed edges and borders, which then leads to corrosion problems during practical use. Finishing coats using color or effect paints then no longer offer suitable corrosion protection. On the other hand, the preformable paint films 4 applied in accordance with the present invention offer an outstanding protection of the edges and borders. The preformable paint films 4 are also particularly advantageous when a specific mechanical load is present due to shock, impact or scuffing at the exposed regions of the components. Here, anti-chip protection paints come to mind, for example.

In contrast to the known processing of the sheet-coated sheet-metal sections, in the method according to the present invention, the preformable film 4 and the wide strip 6 are cut to size separately and reshaped in different process steps, as clearly illustrated in FIG. 1.

The permanent bond between the surface of the completely formed component 6 and the preformable paint film 4 is effected by the adhesive action of the temporarily softened bottom polymer layer and/or by an additional adhesive or adhesion promoter layer in the preformable paint film 4. In this context, adhesives or adhesion promoters may be applied both to the preformable paint film 4, as well as to the component 6.

In one especially preferred embodiment of the present invention, the completely formed component 6 constitutes a component for a motor-vehicle body. These include, in particular, small-sized components which are fit into larger body surfaces, such as gas caps, luggage-compartment trim, crosswise or longitudinal posts or members, door handles and the like.

For these applications in particular, the completely formed components 6 must have an exact and consistent quality of color and effect that does not deviate from the surrounding car body. Here, the preformable paint films 4 and the application method according to the present invention exhibit special advantages over conventional paint finishing.

In another embodiment of the present invention, the preformable paint films are developed as effect films which fulfill decorative tasks or are used for storage media.

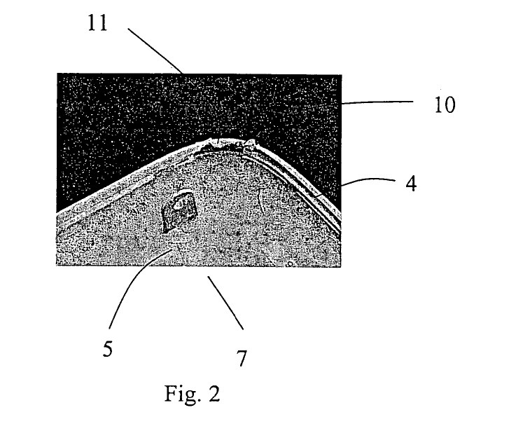

An exemplary component manufactured in accordance with the present invention is shown in FIG. 2 in the form of a gas cap. The gas cap is pictured from the non-laminated bottom side as having exposed sheet metal 5. Preformable paint film 4 is pulled completely over edge region 10 of trimmed edge of the sheet metal. To clarify and illustrate the application of coated and uncoated regions, the preformable paint film 4 is detached in the region designated by reference numeral 11.

Another aspect of the present invention relates to the preformable paint films preferred for the method for manufacturing laminated, completely formed components, and the laminated components themselves. The components 6 laminated with preformable paint film 4 in accordance with the present invention are obtainable in accordance with one of the above mentioned methods. The preformable paint film 4 has one or more thermoplastic polymer layers formed as colored or effect film. In this context, at least the top layer of the preformable paint film 4 is formed or developed to provide coloration and effect.

In a first embodiment of the present invention, the preformable paint film comprises one or more thermoplastic polymer layers. The preformable paint film 4 is formed as colored or effect film, in that at least the top layer of the preformable paint film provides coloration and effect. The preformable paint film 4 has, in particular, no paint coats having color pigments or effect substances. Rather, the substances providing coloration and/or effect are present in one of the polymer layers, preferably in the top layer. In some instances, the preformable paint film 4 may additionally bear a sealing clear coat.

Typically, in the preformable paint films, the pigments or effect substances customary in plastics technology are used, for example, for metallic effects.

In another embodiment of the present invention, the preformable paint film 4 is formed from a backing sheet of thermoplastic polymer or polymer blend and single- or double-layer paint finish disposed thereon, which provides coloration and effect. The paint finish is typically made up of a base coat and a top coat. One embodiment of this variant provides that the top coat or base coat and top coat are first completely cured following the casting operation. This has the advantage that the paints, only partially cured prior to the casting operation, have good plasticity and are able to be reshaped in a stress-free manner. It is not until following the lamination or reshaping operation that the paints are then completely cured, for example in a drying or photochemically initiated curing (UV curing) operation.

Polypropylene, polyurethane, polyethylene, polyethylene terephthalate, polycarbonate, polybutylene terephthalate, polycarbonate, acrylonitrile/styrene/acrylester and/or acryllbutadiene/styrene count among the preferred polymers or polymer blends for the colored film, effect film, or backing sheet.

In one preferred embodiment of the present invention, the colored film, effect film, or backing sheet has two polymer layers, the bottom layer being formed by polypropylene or polyurethane, and the overlying layer by polyethylene or polyethylene terephthalate.

In another embodiment of the present invention, the colored film, effect film, or backing sheet has two polymer layers, the bottom layer being formed by an elastic or viscoelastic material, in particular acryl/butadiene/styrene rubber, polycarbonate, polypropylene and/or polyurethane, and the overlying layer by polycarbonate and/or polybutylene terephthalate.

This film structure is especially suited for areas which are subject to mechanical loads, such as the rearview mirrors of vehicles, doorsills, front-end scuff moldings or fenders. The effect may be further enhanced by viscoelastic aggregates or by a polymer blend including viscoelastic copolymer in the underlying polymer layer.

On the other hand, the thermoplastic polymer of the preformable paint film or backing sheet may also contain aggregates which improve mechanical properties, such as hardness or impact resistance. Preferred aggregates are mineral or ceramic fine powder, for example of SiO₂ or silicates.

The thickness of the film is preferably within the range of 70 to 500 μm, most preferably within the range of 80 to 120 μm. In this context, the thickness of the backing sheet, to the extent that it is present, is 50 to 85% of the total thickness of the preformable paint film.

In another variant, the backing sheet, colored film or effect film has an adhesion promoter layer or adhesive layer on the bottom side. Thermally curable adhesives, such as 2K polyurethane adhesives or acrylate adhesives count among the preferred adhesives. Thermally curable adhesives are cured in the course of the thermo-forming process. The adhesion promoter layer is a fusible material, which becomes soft and adhesive under process conditions, and, once cooled, solidifies again into a connecting layer.

Metals, plastics or composite materials are the typical materials used for the completely formed component 6. Metallic materials, such as steel, in particular, are preferably used. In this context, it is advantageous when the preformable paint film 4 is not applied to the blank steel, but rather to the pre-coated material. As a corrosion protection coating, generally a phosphate or zinc coating is used. It is especially preferred for completely formed components of organically coated steel sheets to be used

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for applying a preformable paint film to a visible surface of a completely formed component, comprising the steps of:
providing a mold tool;
fixing the preformable paint film in the mold tool;
introducing the completely formed component into the mold tool;
heating the preformable paint film to or above a glass-transition temperature of polymer constituents of the preformable paint film; and
fitting the heated preformable paint film onto the visible surface of the completely formed component by causing a pressing movement between the completely formed component and the heated preformable paint film.

2. The method of claim 1 wherein the step of fitting the heated preformable paint film onto the visible surface of the completely formed component is carried out by motion causing the preformable paint film to be pressed onto the visible surface of the completely formed component.

3. The method of claim 2 wherein the preformable paint film is pressed onto the visible surface of the completely formed component by a uniformly applied gas pressure.

4. The method of claim 1 wherein the step of fitting the heated preformable paint film onto the visible surface of the completely formed component is carried out by motion causing movement of the completely formed component into and through the plane defined by the preformable paint film fixed in the mold tool.

5. The method of claim 4 comprising the further steps of providing the preformable paint film in a flat, drawn state for fixing in the mold tool, and transferring the preformable paint film in a bubble-free manner to the visible surface of the completely formed component by traversing motion of the completely formed component.

6. The method of claim 4 comprising the step of utilizing the completely formed component as a die in the step of fitting the heated preformable paint film onto the visible surface of the completely formed component.

7. The method of claim 1 wherein the preformable paint film includes an adhesive layer disposed on a bottom side of the preformable paint film, for permanently joining the preformable paint film to the completely formed component.

8. The method of claim 1 wherein the completely formed component includes an adhesive layer disposed on the visible surface thereof, for permanently joining the preformable paint film to the completely formed component.

9. The method of claim 1 wherein the visible surface of the completely formed component include borders and edges, and wherein the step of fitting the heated preformable paint film onto the visible surface of the completely formed component causes the preformable paint film to completely cover the borders and edges of the visible surface.

10. The method of claim 1 wherein the completely formed component comprises a component for a motor vehicle body.

11. The method of claim 1 wherein the completely formed component comprises metal.

12. The method of claim 1 wherein the completely formed component comprises plastic.

13. The method of claim 1 wherein the completely formed component comprises a plastic composite.

14. The method of claim 1 wherein the completely formed component comprises a sheet metal having on at least one side thereof a corrosion protection coating.

15. The method of claim 1 wherein the preformable paint film is heated to a temperature in the range of 130 to 190° C.

16. The method of claim 1 wherein the step of fitting the heated preformable paint film onto the visible surface of the completely formed component by causing a pressing movement between the completely formed component and the heated preformable paint film is carried out by overlapping steps of i) providing motion causing movement of the completely formed component into and through the plane defined by the preformable paint film fixed in the mold tool and ii) providing motion causing the preformable paint film to be pressed onto the visible surface of the completely formed component.

17. The method of claim 1 wherein the step of fitting the heated preformable paint film onto the visible surface of the completely formed component by causing a pressing movement between the completely formed component and the heated preformable paint film is carried out by simultaneously performing steps of i) providing motion causing movement of the completely formed component into and through the plane defined by the preformable paint film fixed in the mold tool and ii) providing motion causing the preformable paint film to be pressed onto the visible surface of the completely formed component.

18. The method of claim 1 wherein the step of fitting the heated preformable paint film onto the visible surface of the completely formed component by causing a pressing movement between the completely formed component and the heated preformable paint film is carried out by performing, in a sequence, the steps of i) providing motion causing movement of the completely formed component into and through the plane defined by the preformable paint film fixed in the mold tool and ii) providing motion causing the preformable paint film to be pressed onto the visible surface of the completely formed component.

19. A painted component comprising:
a preformed base component; and
a preformed paint film fixed to the base component on a visible surface, the preformed pain film being fixed to the base component by introducing the preformed base component into the mold tool and pressing the preformed base component against the preformed paint film at or above a glass-transition temperature of polymer constituents of the preformed paint film.

20. The painted component of claim 19, wherein the preformed paint film comprises at least one thermoplastic polymer layer and is formed such that at least the top layer of the preformed paint film provides coloration and effect.

21. The painted component of claim 19, wherein the preformed paint film is formed from a backing sheet comprising one of a thermoplastic polymer or polymer blend and a paint finish disposed thereon, to provide coloration and effect.

22. The painted component of claim 19 wherein the preformed paint film includes at least one layer comprising a polymer material having a substance selected from the group consisting of a polypropylene, polyurethane, polyethylene, polyethylene terephthalate, polycarbonate, polybutylene terephthalate, polycarbonate, acrylonitrile/styrene/acrylester, acryl/butadiene/styrene rubber base and combinations thereof.

23. The painted component of claim 19 wherein the preformed paint film includes at least two polymer layers, the two layers comprising a bottom layer being formed from one of a polypropylene or a polyurethane, and an overlying layer formed from one of a polyethylene or a polyethylene terephthalate.

24. The painted component of claim 19 wherein the preformed paint film includes at least two polymer layers, the two layers comprising a bottom layer being formed from a substance selected from a group consisting of acryl/butadiene/styrene rubber, polycarbonate, polyurethane, and combinations thereof, and an overlying layer formed by one of a polycarbonate or a polyethylene terephthalate.

25. The painted component of claim 21 wherein the thickness of the preformed paint film is within the range of about 70 to about 500 μm, and wherein the thickness of the backing sheet comprises 50 to 85% of the total thickness of the preformed paint film.

26. The painted component of claim 19 wherein the preformed paint film includes an adhesive layer.

27. The painted component of claim 19 wherein the component comprises a component of a motor vehicle body.
